(19) United States
(12) Patent Application Publication
(10) Pub. No.: US 2013/0049918 A1
(43) Pub. Date: Feb. 28, 2013

(54) Common Mode Choke Apparatus and Method

(71) Applicants: Dianbo Fu, Plano, TX (US); Baoguo Chen, Shenzhen (CN)

(72) Inventors: Dianbo Fu, Plano, TX (US); Baoguo Chen, Shenzhen (CN)

(73) Assignee: FutureWei Technologies, Inc., Plano, TX (US)

(21) Appl. No.: 13/218,043

(22) Filed: Aug. 25, 2011

(51) Int. Cl. H01F 27/28

(52) U.S. Cl. 336/220

(57) ABSTRACT

An embodiment integrated common mode choke comprises a magnetic core, a magnetic plate, a first winding coil and a second winding coil. The magnetic plate is inserted within an inner circumference of the magnetic core. The first winding coil and the second winding coil are wound are wound in the same direction through the magnetic core. The integrated common mode choke is equivalent to a common mode choke and a differential mode choke connected in series. The inductance value of the differential mode choke can be changed by adjusting either the gap between the magnetic plate and the magnetic core or the thickness of the magnetic plate.

### TECHNICAL FIELD

The present invention relates to a common mode choke apparatus and method for power converters, and more particularly, to an integrated common mode choke apparatus and method comprising both a common mode choke and a differential mode choke.

### BACKGROUND

A telecommunication network power system usually includes an ac-dc stage converting the power from the ac utility line to a 48V dc distribution bus and a dc/dc stage converting the 48V dc distribution bus to a plurality of voltage levels for all types of telecommunication loads. A conventional ac-dc stage may comprise a variety of EMI filters, a bridge rectifier formed by four diodes, a power factor correction circuit and an isolated dc/dc power converter. The dc/dc stage may comprise a plurality of isolated dc/dc converters. Isolated dc/dc converters can be implemented by using different power topologies, such as LLC resonant converters, flyback converters, forward converters, half bridge converters, full bridge converters and the like.

In a telecommunication network power system, isolated dc/dc converters may generate common mode noise and differential mode noise. More particularly, an isolated dc/dc converter may comprise at least one primary side switch to chop an input dc voltage so as to generate an ac voltage across the primary side of a transformer. In order to achieve a compact solution, the isolated dc/dc converter may operate at a high switching frequency such as 1 MHz. Such a high switching frequency may generate a high and fast voltage swing across the primary side. Furthermore, there may be a plurality of parasitic capacitors coupled between the primary side and the secondary side of the transformer. The high frequency voltage swing and the parasitic capacitors result in common mode noise in an isolated dc/dc converter because the parasitic capacitors of the transformer provide a low impedance conductive path for common mode current derived from the high frequency voltage swing. On the other hand, the switching ripple of the isolated dc/dc converter may generate differential mode noise, which has a major noise component at the switching frequency of the isolated dc/dc converter and a variety of noise components at other frequencies.

In order to control the electromagnetic interference (EMI) pollution from common mode noise and differential noise, a variety of international standards have been introduced. For example, EMI standard EN55022 Class B is applicable to isolated dc/dc converters. In accordance with a conventional technique, an EMI filter may comprise a common mode choke, a differential mode choke, a plurality of common mode bypass capacitors and a plurality of differential mode bypass capacitors. An effective EMI filter can attenuate both common mode noise and differential mode noise so that the telecommunication network power system can satisfy the requirements of EMI standard EN55022 Class B.

### SUMMARY OF THE INVENTION

These and other problems are generally solved or circumvented, and technical advantages are generally achieved, by preferred embodiments of the present invention which provide an integrated common mode choke for reducing common mode noise as well as differential mode noise in an isolated power converter.

In accordance with an embodiment, an apparatus comprises a magnetic core, a magnetic plate inserted within an inner circumference of the magnetic core, a first winding coil wound around the magnetic core and a second winding coil wound around the magnetic core.

In accordance with another embodiment, a system comprises a first differential mode bypass capacitor, a second differential mode bypass capacitor and an integrated common mode choke. The integrated common mode choke is coupled between the first differential mode bypass capacitor and the second differential mode bypass capacitor.

The integrated common mode choke comprises a magnetic core, a magnetic plate inserted within an inner circumference of the magnetic core, a first winding coil wound around the magnetic core and a second winding coil wound around the magnetic core.

The system further comprises a first common mode bypass capacitor and a second common mode bypass capacitor. The first common mode bypass capacitor and the second common mode bypass capacitor are connected in series.

In accordance with yet another embodiment, a method comprises inserting a magnetic plate within an inner circumference of a circular ring-shaped magnetic core, configuring a first winding coil wound at a left side of the magnetic plate and configuring a second winding coil wound at a left side of the magnetic plate wherein the first winding coil and the second winding coil are wound in a same direction through the circular ring-shaped magnetic core.

An advantage of an embodiment of the present invention is an integrated common mode choke can reduce both common mode noise and differential mode noise.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a schematic diagram of an electromagnetic interference filter in accordance with an embodiment;

FIG. 2 illustrates an integrated common mode choke on a single magnetic core capable of filtering both common mode noise and differential mode noise;

FIG. 3 illustrates an electrical equivalent circuit of the integrated common mode choke in accordance with an embodiment;

FIG. 4 illustrates a magnetic circuit conducting common mode flux and differential mode flux respectively;

FIG. 5 illustrates a diagram of adjusting the differential inductance of the integrated common mode choke by positioning the magnetic plate; and

FIG. 6 illustrates a magnetic equivalent circuit of the integrated common mode choke shown in FIG. 2.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely an integrated common mode choke for an isolated dc/dc power converter. The invention may also be applied, however, to a variety of power converters including both isolated power converters such as forward converters and non-isolated power converters such as buck converters. Furthermore, the invention may also be applied to a variety of power factor correction circuits.

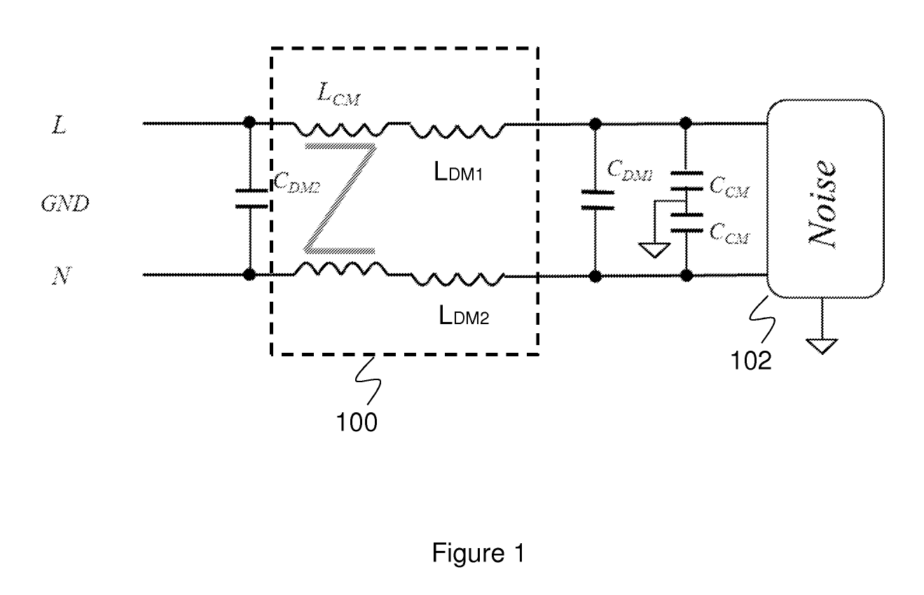

Referring initially to FIG. 1, a schematic diagram of an electromagnetic interference (EMI) filter is illustrated in accordance with an embodiment. The EMI filter comprises an integrated common mode choke 100 and four bypass capacitors. As shown in FIG. 1, the EMI filter is coupled between a noise source 102 and the output lines of a prime power supply (not shown). The noise source 102 represents the common mode noise and differential mode noise generated by a switching power converter (not shown). The EMI filter may also be applied to a variety of isolated power converters including LLC resonant converters half bridge converters, full bridge converters, flyback converters, forward converters, push-pull converters and the like. Furthermore, The EMI filter may also be applied to a variety of non-isolated power converters including buck switching converters, boost switching converters, buck-boost switching converter and the like.

The integrated common mode choke 100 comprises a common mode choke L_{CM} and two differential inductors, namely L_{DM1} and L_{DM2}. When a differential current such as the normal operation current of the switching power converter (not shown) passes through the common mode choke L_{CM}, the differential current cancels out in two windings of the common mode choke L_{CM}. As a result, there is no net magnetization of the core of the common mode choke L_{CM}. Consequently, the common mode choke L_{CM} has no impact on the differential current. In contrast, when a common mode noise current passes through the common mode choke L_{CM}, the common mode noise current magnetizes the core of the common mode choke L_{CM}. As a result, the common mode choke L_{CM} show high impedance for the common mode noise current so as to prevent the common mode noise current from polluting the prime power supply (not shown).

Two common mode bypass capacitors C_{CM} are connected in series and coupled between the two outputs of the noise source 102. The joint node of two common mode bypass capacitors C_{CM} is coupled to ground. In accordance with an embodiment, the common mode bypass capacitor C_{CM} has a capacitance value of 2200 Pico Farad (pF). A first differential mode bypass capacitor C_{DM1} is coupled between the outputs of the noise source 102 and connected in parallel with the common mode bypass capacitors C_{CM}. In accordance with an embodiment, the first differential mode bypass capacitor C_{DM1} has a capacitance value of 100 Nano Farad (nF). As shown in FIG. 1, both the first differential capacitor C_{DM1} and the common mode bypass capacitors C_{CM} are located between the noise source 102 and the integrated common mode choke 100.

A second differential mode bypass capacitor C_{DM2} is located at the other side of the integrated common mode choke 100. The second differential mode bypass capacitor C_{DM2} is coupled between the input lines of the prime power source (not shown). In accordance with an embodiment, the second differential mode bypass capacitor C_{DM2} has a capacitance value of 100 nF. One advantageous feature of having the integrated common mode choke 100 is that combining a common mode choke and a differential mode choke on a single magnetic core can reduce the cost and physical size of the EMI filter shown in FIG. 1.

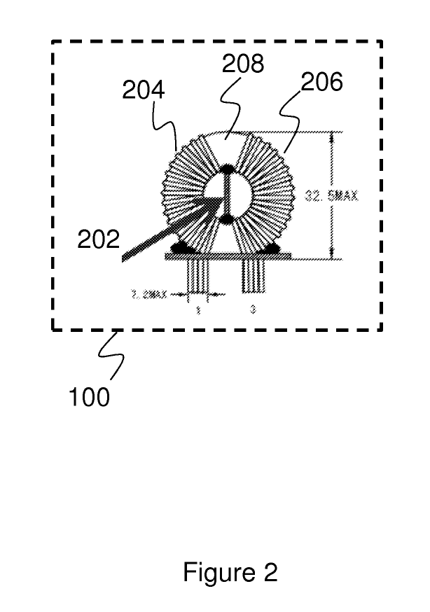

FIG. 2 illustrates an integrated common mode choke on a single magnetic core capable of filtering both common mode noise and differential mode noise. The integrated common mode choke 100 comprises two winding coils 204 and 206 wound around a toroidal magnetic core 208. In addition, the integrated common mode choke 100 comprises a magnetic plate inserted between two windings 204 and 206. As shown in FIG. 2, a first winding coil 204 is wound at the left side of the magnetic plate 202. Likewise, a second winding coil 206 is wound at the right side of the magnetic plate 202. The size of the magnetic plate 202 is proportional to the size of the toroidal core 208. For example, in a high power application, a large toroidal magnetic core may be selected on the basis of core flux density. As a result, the length of the magnetic plate 202 is increased to fit the inner diameter of the toroidal magnetic core 208.

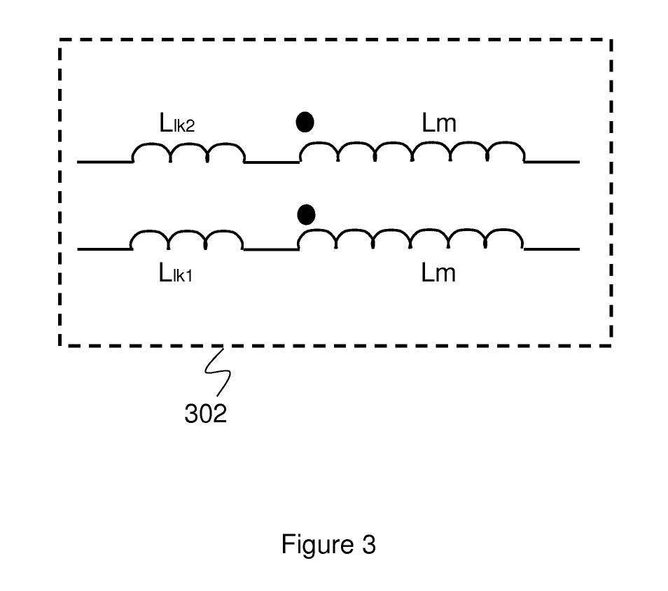

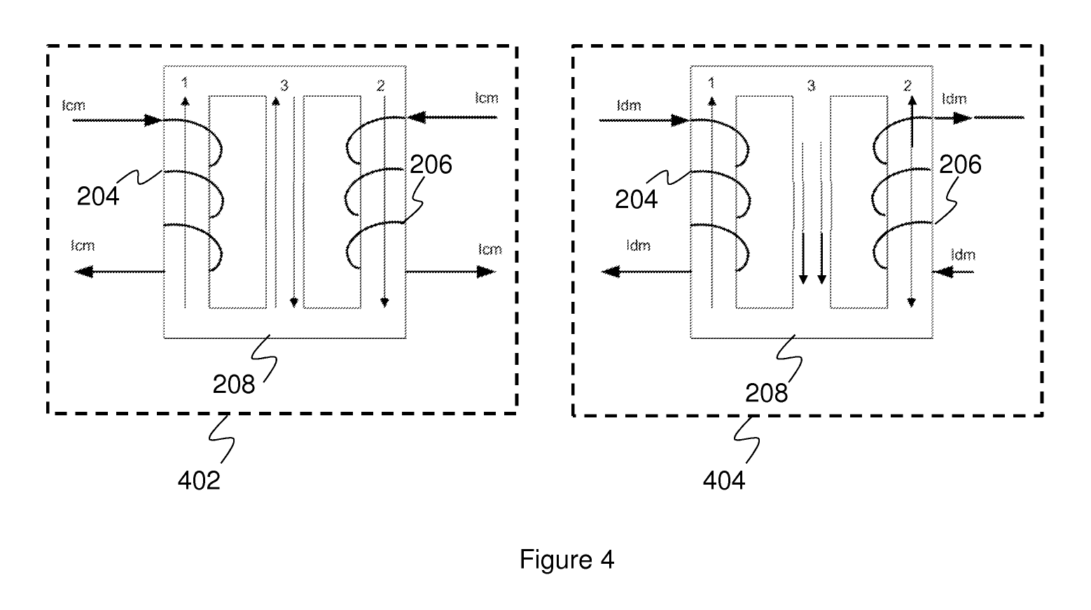

In accordance with an embodiment, the magnetic plate 202 is made of ferrite or the like. In particularly, when the integrated common mode choke 100 is applied to high frequency applications, the magnetic plate 202 made of ferrite may cause low energy losses. On the other hand, in accordance with another embodiment, the magnetic plate 202 is made of powder iron or other powder metal materials. In low frequency applications, the magnetic plate 202 made of powder iron is selected because a powder iron core may have a greater saturation flux density than a corresponding ferrite core. It should be noted that in comparison with conventional partition plates made of insulating materials such as plastics and rubber, the magnetic plate 202 is made of a magnetic material having high permeability. Furthermore, such a magnetic material helps to increase the leakage inductance of the integrated common mode choke 100. The increased leakage inductance makes it unnecessary to employ a dedicated differential mode choke. In fact, the equivalent circuit of the integrated common mode choke 100 shows that a common mode inductance is connected in series with a differential mode inductance. The detailed explanation of the equivalent circuit will be described below with respect to FIG. 3 and FIG. 4.

FIG. 3 illustrates an electrical equivalent circuit of the integrated common mode choke in accordance with an embodiment. As shown in FIG. 3, the electrical equivalent circuit 302 includes a common mode choke Lₘ and two differential mode inductors, namely Lₗₖ₁ and Lₗₖ₂. As described above with FIG. 2, there are no dedicated differential inductors necessary for the integrated common mode choke 100 (illustrated in FIG. 1). The leakage inductances of the integrated common mode choke 100 can be increased to a level significant enough to filter the differential noise from the noise source 102 (illustrated in FIG. 1).

FIG. 4 illustrates a magnetic circuit conducting common mode flux and differential mode flux respectively. The magnetic circuit 402 illustrates that the common mode fluxes generated by the first winding coil 204 and the second winding coil 206 are canceled out in the magnetic plate 202. As a result, the magnetic plate 202 has no impact on the inductance value of the common mode choke Lₘ (shown in FIG. 3). On the other hand, when a differential mode current passes through the integrated common mode choke 100, the magnetic circuit 404 shows that the fluxes generated by the first winding coil 204 and the second winding coil 206 are added together at the magnetic plate 202. As a result, the magnetic plate 202 functions a differential mode choke to prevent the differential mode current from passing through the integrated common mode choke 100. An advantageous feature of having the magnetic plate 202 is that the magnetic plate 202 has no impact on the performance of the common mode chock Lₘ while filtering differential mode noise.

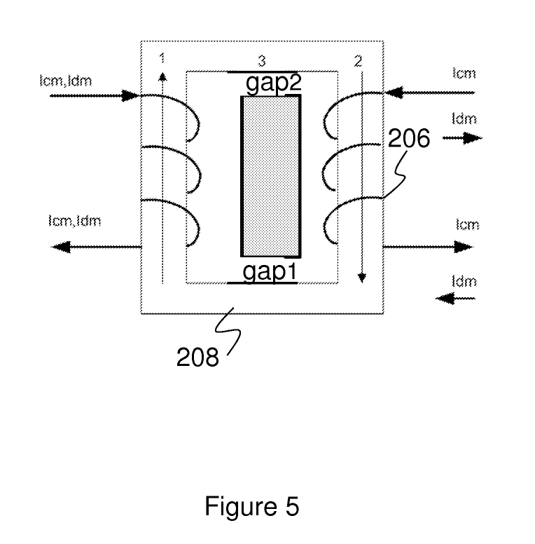

FIG. 5 illustrates a diagram of adjusting the differential inductance of the integrated common mode choke by positioning the magnetic plate. As shown in FIG. 5, there may be two gaps between the magnetic plate 202 and the magnetic core 208. More particularly, a first gap is located between a lower side of the magnetic plate 202 and an inner wall of the magnetic core 208. Likewise, a second gap is located between an upper side of the magnetic plate 202 and the inner wall of the magnetic core. By using a different magnetic plate such as a smaller one, both gaps are increased so that the differential inductance of the integrated common mode choke may be reduced as a result. Furthermore, by adjusting the position of the magnetic plate 202, either the first gap or the second gap can be increased or decreased accordingly. As a result, the differential inductance (not shown) of the integrated common mode choke 100 varies accordingly.

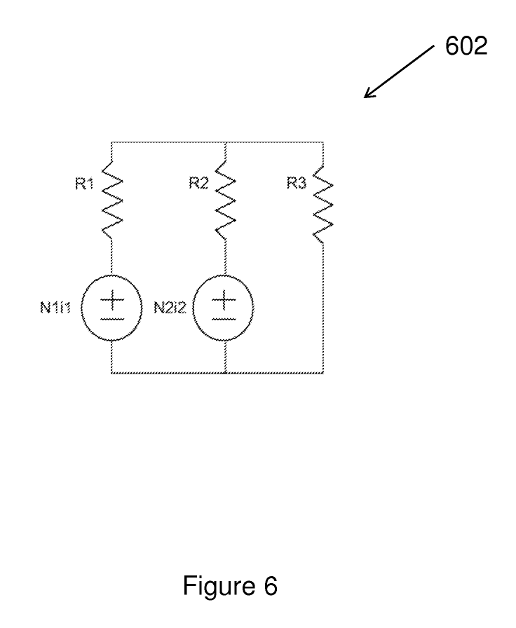

FIG. 6 illustrates a magnetic equivalent circuit of the integrated common mode choke shown in FIG. 2. A first magnetomotive force N1ᵢ₁ is generated by the first winding coil 204. Similarly, a second magnetomotive force N2ᵢ₂ is generated by the second winding coil 206. A first reluctance R1 and a second reluctance R2 are modeled based upon the magnetic characteristics of the magnetic core 208 (illustrated in FIG. 2). A third reluctance R3 is modeled based upon the magnetic characteristics of the magnetic plate 202 (illustrated in FIG. 2). In accordance with an embodiment, by employing magnetic circuit theory similar to Ohm's law in electrical circuit theory, the differential inductance of the integrated common mode choke 100 can be defined as the follows:

$${L}_{dm} = \frac{{N}_{1}^{2}}{{R}_{1} + 2 {R}_{3}}$$

where N1 is the turns of the first winding coil 204. The equation above shows that the differential inductance of the integrated common mode choke 100 is kind of inversely proportional to the third reluctance R3. In other words, by adjusting the third reluctance R3, the differential inductance is adjusted accordingly. As described above with respect to FIG. 5, the differential inductance of the integrated common mode choke 100 can be adjusted by changing the gaps between the magnetic plate 202 and the inner wall of the toroidal magnetic core 208. On the other hand, in accordance with another embodiment, the thickness of the magnetic plate 202 can be increased so as to reduce the third reluctance R3. As a result, the differential inductance of the integrated common mode choke 100 can be increased accordingly.

Although embodiments of the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. An apparatus comprising:
a magnetic core;
a magnetic plate disposed within an inner circumference of the magnetic core, wherein the magnetic plate is separated from an inner wall of the magnetic core by a first gap and a second gap;
a first winding coil wound around the magnetic core; and
a second winding coil wound around the magnetic core.

2. The apparatus of claim 1, wherein the magnetic core is a circular ring-shaped core.

3. The apparatus of claim 2, wherein the first winding coil and the second winding coil are wound in a same direction through the circular ring-shaped core.

4. The apparatus of claim 1, wherein the first winding coil is on a first side of the magnetic plate.

5. The apparatus of claim 4, wherein the second winding coil is on a second side opposite the first side of the magnetic plate.

6. The apparatus of claim 1, wherein the magnetic plate comprises ferrite.

7. The apparatus of claim 1, wherein the magnetic plate comprises powder iron.

8. The apparatus of claim 1, wherein:
the first gap is between an upper side of the magnetic plate and the inner wall of the magnetic core; and
the second gap is between a lower side of the magnetic plate and the inner wall of the magnetic core.

9. A system comprising:
a first differential mode bypass capacitor;
a second differential mode bypass capacitor;
a magnetic core;
a magnetic plate inserted within an inner circumference of the magnetic core, wherein the magnetic plate is separated from an inner wall of the magnetic core by a first gap and a second gap;
a first winding coil wound around the magnetic core;
a second winding coil wound around the magnetic core, the magnetic core, the magnetic plate, the first winding coil, the second winding coil forming an integrated common mode choke coupled between the first differential mode bypass capacitor and the second differential mode bypass capacitor;
a first common mode bypass capacitor coupled to the first differential mode bypass capacitor; and
a second common mode bypass capacitor coupled to the first differential mode bypass capacitor, wherein the first common mode bypass capacitor and the second common mode bypass capacitor are connected in series.

10. The system of claim 9, wherein a joint node of the first common mode bypass capacitor and the second common mode bypass capacitor is connected to ground.

11. The system of claim 9, wherein the magnetic plate comprises ferrite.

12. The system of claim 9, wherein the magnetic plate comprises powder iron.

13. The system of claim 9, wherein the first differential mode bypass capacitor is connected in parallel with a common mode noise filtering path formed by the first common mode bypass capacitor and the second common mode bypass capacitor connected in series.

14. The system of claim 13, wherein the common mode noise filtering path is coupled to two input terminals of a noise source.

15. The system of claim 9, wherein the integrated common mode choke comprises:
a common mode choke; and
a differential mode choke comprising a first differential inductor and a second differential inductor, wherein the common mode choke and the differential mode choke are connected in series.

16. A method comprising:
inserting a magnetic plate within an inner circumference of a circular ring-shaped magnetic core;
winding a first winding coil at a first side of the magnetic plate; and
winding a second winding coil at a second side opposite the first side of the magnetic plate, wherein the first winding coil and the second winding coil are wound in a same direction around the circular ring-shaped magnetic core.

17. The method of claim 16, further comprising:
forming a first gap between an upper side of the magnetic plate and an adjacent section of an inner wall of the circular ring-shaped magnetic core; and
forming a second gap between a lower side of the magnetic plate and an adjacent section of the inner wall of the circular ring-shaped magnetic core.

18. The method of claim 17, further comprising:
positioning the magnetic plate and the circular ring-shaped magnetic core with respect to each other;
adjusting the first gap between the upper side of the magnetic plate and the inner wall of the circular ring-shaped magnetic core; and
adjusting the second gap between the lower side of the magnetic plate and the inner wall of the circular ring-shaped magnetic core.

19. The method of claim 16, further comprising:
adjusting a thickness of the magnetic plate so as to change a leakage inductance value of an integrated common mode choke formed by the circular ring-shaped magnetic core, the magnetic plate, the first winding coil and the second winding coil.

20. The method of claim 16, further comprising:
forming an integrated common mode choke including a common mode choke from the first winding coil and the second winding coil and a differential mode choke from leakage inductance of the integrated common mode choke; and
adjusting an inductance value of the differential mode choke by changing a parameter of the magnetic plate.
